(19) United States
(12) Patent Application Publication
(10) Pub. No.: US 2024/0369468 A1
(43) Pub. Date: Nov. 7, 2024

(54) IMAGING SYSTYEMS AND RELATED METHODS

(71) Applicant: ILLUMINA, INC., San Diego, CA (US)

(72) Inventors: Steven Boege, San Mateo, CA (US); Danilo Condello, New York, NY (US); Simon Prince, Carlsbad, CA (US); Jason Bryant, Cambridge (GB); Merek Siu, Alameda, CA (US)

(21) Appl. No.: 18/572,189

(22) PCT Filed: Dec. 27, 2022
(86) PCT No.: PCT/US2022/054084

§ 371 Date: Dec. 20, 2023

Related U.S. Application Data
(60) Provisional application No. 63/294,968, filed on Dec. 30, 2021.

(51) Int. Cl. G01N 15/1434; G01N 15/10; G01N 15/14

(52) U.S. Cl. CPC G01N 15/1434; G01N 15/1459; G01N 2015/1006; G01N 2015/144; G01N 2015/145

(57) ABSTRACT

Imaging systems and related methods are disclosed. In accordance with an implementation, a system includes a flow cell receptacle to receive a flow cell that receives a sample and an imaging system having a light source assembly, and an imaging device. The light source assembly to form a substantially collimated beam. The optical assembly including an asymmetric beam expander group that includes one or more asymmetric elements or anamorphic elements disposed along an optical axis. The optical assembly to receive the substantially collimated beam from the light source assembly, and transform the substantially collimated beam into a shaped sampling beam having an elongated cross section in a far field at or near a focal plane of the optical assembly to optically probe the sample. The imaging device to obtain image data associated with the sample in response to the optical probing of the sample with the sampling beam.

### RELATED APPLICATION SECTION

This application claims the benefit of and priority to U.S. Provisional Patent Application No. 62/294,968, filed Dec. 30, 2021, the content of which is incorporated by reference herein in its entireties and for all purposes.

### BACKGROUND

Instruments such as sequencing instruments may image samples on a flow cell.

### SUMMARY

Advantages over the prior art and benefits as described later in this disclosure can be achieved through the provision of imaging systems and related methods. Various implementations of the apparatuses and methods are described below, and the apparatuses and methods, including and excluding the additional implementations enumerated below, in any combination (provided these combinations are not inconsistent), may overcome these shortcomings and achieve the benefits described herein.

In accordance with a first implementation, an apparatus comprises or includes a flow cell and a system. The flow cell to receive a sample. The system comprises or includes a flow cell receptacle and an imaging system. The flow cell receptacle to receive the flow cell. The imaging system comprising or including a light source assembly, an optical assembly, and an imaging device. The light source assembly to form a substantially collimated beam. The optical assembly comprising or including an asymmetric beam expander group that comprises or includes one or more asymmetric elements or anamorphic elements disposed along an optical axis. The optical assembly to receive the substantially collimated beam from the light source assembly, and transform the substantially collimated beam into a shaped sampling beam comprising or having an elongated cross section in a far field at or near a focal plane of the optical assembly to optically probe the sample in the flow cell. The imaging device to obtain image data associated with the sample in response to the optical probing of the sample with the shaped sampling beam.

In accordance with a second implementation, a system comprises or includes a flow cell receptacle and an imaging system. The flow cell receptacle to receive a flow cell that receives a sample and the imaging system comprising or including a light source assembly, and an imaging device. The light source assembly to form a substantially collimated beam. The optical assembly comprising or including an asymmetric beam expander group that comprises or includes one or more asymmetric elements or anamorphic elements disposed along an optical axis. The optical assembly to receive the substantially collimated beam from the light source assembly, and transform the substantially collimated beam into a shaped sampling beam comprising or having an elongated cross section in a far field at or near a focal plane of the optical assembly to optically probe the sample in the flow cell. The imaging device to obtain image data associated with the sample in response to the optical probing of the sample with the sampling beam.

In accordance with a third implementation, a method comprises or includes generating a collimated beam using a light source assembly and transforming the collimated beam into a shaped sampling beam comprising or having an elongated cross section in a far field at a focal plane of an optical assembly using the optical assembly. The optical assembly has an asymmetric beam expander group that comprises or includes one or more asymmetric elements or anamorphic elements disposed along an optical axis. The method also comprises or includes optically probing a sample with the shaped sampling beam.

In further accordance with the foregoing first, second, and/or third implementations, an apparatus and/or method may further comprise or include any one or more of the following:

In accordance with an implementation, the substantially collimated beam has a first aspect ratio and the shaped sampling beam has a second aspect ratio.

In accordance with another implementation, the first aspect ratio of the substantially collimated beam is at most 4:1, and the second aspect ratio of the shaped sampling beam is at least 8:1.

In accordance with another implementation, the asymmetric beam expander group is to provide a first magnification in a first axis, and a second different magnification in a second different axis.

In accordance with another implementation, the first magnification is at least twice the second magnification.

In accordance with another implementation, the optical assembly comprises or includes the asymmetric beam expander group and an objective group. The asymmetric beam expander group to asymmetrically or anamorphically expand the substantially collimated beam comprising or having a first aspect ratio to form a shaped beam comprising or having a second different aspect ratio; and an objective group disposed along the optical axis to receive the shaped beam from the asymmetric beam expander group, and transform the shaped beam into the shaped sampling beam at or near the focal plane of the optical assembly.

In accordance with another implementation, the light source assembly comprises or includes a beam source to provide input radiation, and a collimator to substantially collimate the input radiation to form the substantially collimated beam comprising or having a first aspect ratio.

In accordance with another implementation, the collimator comprises or includes a waveguide comprising or having the first aspect ratio.

In accordance with another implementation, the waveguide comprises or includes at least one of a rectangular optical fiber, or a light pipe comprising or having the first aspect ratio.

In accordance with another implementation, the collimator comprises or includes at least one of a spherical lens or an aspherical lens disposed to collimate an output of the optical fiber.

In accordance with another implementation, the optical assembly comprises or includes a beam shaping group, the asymmetric beam expander group, and an objective group. The beam shaping group comprising or having one or more optical elements disposed along the optical axis to receive the substantially collimated beam from the collimator, and transform the substantially collimated beam into a first shaped beam comprising or having a first aspect ratio. The asymmetric beam expander group is to asymmetrically or anamorphically expand the first shaped beam comprising or having the first aspect ratio to form a second shaped beam comprising or having a second different aspect ratio. The objective group disposed along the optical axis to receive the second shaped beam from the asymmetric beam expander group, and transform the second shaped beam into the shaped sampling beam at or near the focal plane of the optical assembly.

In accordance with another implementation, the imaging device comprises or includes a time domain integration (TDI) image sensor comprising or having an aspect ratio corresponding to an aspect ratio of the sampling beam.

In accordance with another implementation, the asymmetric beam expander group comprises or includes one or more pairs of crossed cylindrical lenses disposed along the optical axis.

In accordance with another implementation, each pair of the one or more pairs of crossed cylindrical lenses comprises or includes two cylindrical lenses with different powers and oriented on different axes.

In accordance with another implementation, the asymmetric beam expander group comprises or includes a cylindrical telescope disposed along the optical axis.

In accordance with another implementation, the cylindrical telescope comprises or includes a singlet lens.

In accordance with another implementation, the cylindrical telescope comprises or includes an afocal doublet lens.

In accordance with another implementation, the doublet lens is achromatic.

In accordance with another implementation, the cylindrical telescope is at least one of a Keplerian telescope, a Galilean telescope, or a hybrid Keplerian-Galilean telescope.

In accordance with another implementation, the asymmetric beam expander group comprises or includes a second cylindrical telescope.

In accordance with another implementation, the cylindrical telescope and the second cylindrical telescope are at least one of in series, nested, or interleaved.

In accordance with another implementation, the cylindrical telescope and the second cylindrical telescope magnify by different amounts in different axes.

In accordance with another implementation, the asymmetric beam expander group comprises or includes one or more anamorphic prisms disposed along the optical axis such that magnification is provided in substantially one axis.

In accordance with another implementation, the one or more anamorphic prisms comprise or include a first prism comprising or including a first glass type and a second prism comprising or including a second glass type.

In accordance with another implementation, the asymmetric beam expander group includes one or more diffractive elements disposed along the optical axis.

In accordance with another implementation, the one or more diffractive elements comprise or include at least one of a refractive homogenizer, a refractive diffuser, or a cylindrical microlens array.

In accordance with another implementation, the asymmetric beam expander group comprises or includes a lens disposed along the optical axis. The imaging system to move the lens along the optical axis to switch the asymmetric beam expander group between a high irradiance mode and a low irradiance mode.

In accordance with another implementation, the imaging system further comprises or includes an actuator and a reflective element. The actuator to position the reflective element to sweep the shaped sampling beam across the flow cell within an exposure time.

In accordance with another implementation, the asymmetric beam expander group further comprises or includes at least one of a crossed pair of cylindrical lens, a cylindrical telescope, an anamorphic prism, or a diffractive element to provide anamorphic expansion along a first axis. The actuator is to position the reflective element to sweep the shaped sampling beam along a second, different axis.

In accordance with another implementation, the actuator is to position the reflective element within a range to sweep the shaped sampling beam across the flow cell.

In accordance with another implementation, the range is between about 39 degrees and about 41 degrees.

In accordance with another implementation, generating the collimated beam comprises or includes passing an input beam through a waveguide.

In accordance with another implementation, the waveguide comprises or includes at least one of a rectangular optical fiber or a light pipe.

In accordance with another implementation, transforming the collimated beam into the shaped sampling beam comprises or includes asymmetrically or anamorphically expanding the substantially collimated beam comprising or having a first aspect ratio using the asymmetric beam expander group to form a shaped beam comprising or having a second aspect ratio.

In accordance with another implementation, transforming the collimated beam into the shaped sampling beam comprises or includes transforming the shaped beam into the shaped sampling beam at or near the focal plane of the optical assembly using an objective group disposed along the optical axis.

In accordance with another implementation, asymmetrically or anamorphically expanding the substantially collimated beam comprises or includes passing the substantially collimated beam through at least one of: 1) one or more pairs of crossed cylindrical lenses; 2) one or more cylindrical telescopes; 3) one or more anamorphic prisms; or 4) one or more diffractive elements.

In accordance with another implementation, asymmetrically or anamorphically expanding the substantially collimated beam comprises or includes moving a lens of the asymmetric beam expander group along the optical axis to switch the asymmetric beam expander group between a high irradiance mode and a low irradiance mode.

In accordance with another implementation, the method also comprises or includes sweeping the shaped sampling beam across the sample.

In accordance with another implementation, sweeping the shaped sampling beam across the sample comprises or includes directing the shaped beam to a reflective element and rotating the reflective element with an actuator.

In accordance with another implementation, transforming the collimated beam into the shaped sampling beam comprises or includes transforming the substantially collimated beam into a first shaped beam having a first aspect ratio using a beam shaping group having one or more optical elements disposed along the optical axis; and asymmetrically or anamorphically expanding the first shaped beam having the first aspect ratio using the asymmetric beam expander group to form a second shaped beam having a second different aspect ratio.

In accordance with another implementation, transforming the collimated beam into the shaped sampling beam comprises or includes transforming the second shaped beam into the shaped sampling beam at or near the focal plane of the optical assembly using an objective group disposed along the optical axis.

In accordance with another implementation, asymmetrically or anamorphically expanding the first shaped beam magnifies the first shaped beam by a first magnification in a first axis, and by a second different magnification in a second different axis.

In accordance with another implementation, the first magnification is at least twice the second magnification.

In accordance with another implementation, asymmetrically or anamorphically expanding the first shaped beam comprises or includes passing the first shaped beam through one or more pairs of crossed cylindrical lenses.

In accordance with another implementation, asymmetrically or anamorphically expanding the first shaped beam comprises or includes passing the first shaped beam through one or more cylindrical telescopes.

In accordance with another implementation, asymmetrically or anamorphically expanding the first shaped beam comprises or includes passing the first shaped beam through one or more anamorphic prisms.

In accordance with another implementation, asymmetrically or anamorphically expanding the first shaped beam comprises or includes passing the first shaped beam through one or more diffractive elements.

In accordance with another implementation, asymmetrically or anamorphically expanding the first shaped beam comprises or includes passing the first shaped beam through a lens; and moving the lens along the optical axis to switch the asymmetric beam expander group between a high irradiance mode and a low irradiance mode.

In accordance with another implementation, the method comprises or includes sweeping the shaped sampling beam across the sample by directing the second shaped beam to a reflective element and rotating the reflective element with an actuator.

In accordance with another implementation, the method comprises or includes obtaining image data associated with the sample in response to the optical probing of the sample with the shaped sampling beam.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

The accompanying figures, where like reference numerals refer to identical or functionally similar elements throughout the separate views, together with the detailed description below, are incorporated in and form part of the disclosure, and serve to further illustrate example implementations that include the claimed invention, and explain various principles and advantages of those examples. Moreover, the figures only show those specific details that are pertinent to understanding the examples of the disclosure so as not to obscure the disclosure with details that will be readily apparent to those of ordinary skill in the art having the benefit of the description herein.

FIG. 1 illustrates a schematic diagram of an example implementation of a system in accordance with teachings of the disclosure.

FIG. 2 is a schematic diagram of a portion of an example imaging system that can be used to implement the imaging system of FIG. 1.

FIG. 3 is a schematic diagram of an example asymmetric beam expander group that can be used to implement the asymmetric beam expander group of FIGS. 1 and/or 2.

FIG. 4 is a schematic diagram of another example asymmetric beam expander group that can be used to implement the asymmetric beam expander group of FIGS. 1 and/or 2.

FIG. 5 is a schematic diagram of another example asymmetric beam expander group that can be used to implement the asymmetric beam expander group of FIGS. 1 and/or 2.

FIG. 6 shows an example pattern of illumination generated using the asymmetric beam expander group of FIG. 5 when each of the prisms are formed of the same type of glass.

FIG. 7 shows an example pattern of illumination generated using the asymmetric beam expander group of FIG. 5 when the prisms are formed of two or more types of glass.

FIG. 8 is a schematic diagram of another example asymmetric beam expander group that can be used to implement the asymmetric beam expander group of FIGS. 1 and/or 2.

FIG. 9 is a schematic diagram of another example asymmetric beam expander group that can be used to implement the asymmetric beam expander group of FIGS. 1 and/or 2.

FIG. 10 shows a high irradiance, elongated beam pattern that can be generated with the asymmetric beam expander group of FIG. 9 being in a first position.

FIG. 11 shows a low irradiance, broader beam pattern that can be generated with the asymmetric beam expander group of FIG. 9 being in a second position.

FIG. 12 is a schematic diagram of another asymmetric beam expander group that can be used to implement the asymmetric beam expander group of FIGS. 1 and/or 2, with a reflective element in a first position.

FIG. 13 is a schematic diagram of the asymmetric beam expander group of FIG. 12 showing the reflective element in a second position.

FIG. 14 is a schematic diagram of the asymmetric beam expander group of FIG. 12 showing the reflective element in a third position.

FIG. 15 shows a pattern of illumination showing a sampling beam generated using the asymmetric beam expander group of FIG. 12 with the reflective element in a first position.

FIG. 16 shows a pattern of illumination showing the sampling beam generated using the asymmetric beam expander group of FIG. 13 with the reflective element in a second position.

FIG. 17 shows a pattern of illumination showing the sampling beam generated using the asymmetric beam expander group of FIG. 14 with the reflective element in a third position.

FIG. 18 is a flowchart of an example process of using the system of FIG. 1, the imaging system of FIGS. 1 and 2, the optical assemblies of FIGS. 1 and/or 2, and/or the asymmetric beam expander groups of FIGS. 1, 2, 3, 4, 5, 8, 9, and/or 12.

The apparatus and method components have been represented where appropriate by conventional symbols in the drawings, showing only those specific details that are pertinent to understanding implementations of the disclosure so as not to obscure the disclosure with details that will be readily apparent to those of ordinary skill in the art having the benefit of the description herein.

### DETAILED DESCRIPTION

Although the following description discloses detailed descriptions of implementations of methods, apparatuses, and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

At least one aspect of the disclosure is directed toward instruments such as line scanning sequencing instruments that can be used to perform an analysis on one or more samples of interest (e.g., a biologic specimen). The instruments include an optical assembly designed to receive an input beam from a beam source and covert that input beam into a sampling beam for optically probing the sample. While a laser, laser diode, diode-pumped solid-state laser, coherent light source, light emitting diode, or any other laser like source may be used to form the input beam, such sources often output a narrowly focused, non-uniform, high irradiance beam. The use of such a narrowly focused, non-uniform, high irradiance beam to illuminate a sample may, however, cause photobleaching of the sample, photodamage to the sample, photodamage to reagents used for performing chemical reactions, and/or photodamage to a substrate used to support the sample.

Disclosed optical assemblies accordingly transform the input beam into a larger shaped beam for optically probing a sample. An example shaped beam has a thin or otherwise elongated, substantially rectangular cross section in a far field, with the shaped beam having a substantially uniform irradiance across the cross section. By spreading the irradiance of the input beam over a larger area, photobleaching of the sample, photodamage to the sample, photodamage to reagents used for performing chemical reactions, and/or photodamage to a substrate used to support the sample can be reduced. The irradiance provided by such a larger shaped beam can, however, be made to be sufficient to cause enough fluorescence emissions from the sample to allow for sequencing of the sample. The irradiance provided by such shaped beams, moreover, enables the instruments to operate at an increased speed, as the substantially more uniform excitation illumination results in the illumination of edges of an area of excitation illumination. Such shaped beams also enable the use of a time delay and integration (TDI) line scanner, which often have a large aspect ratio (e.g., at least 8:1). While examples are described herein that generate sampling beams having an elongated, substantially rectangular cross section, the present techniques may be used to form any number of elongated cross section geometries in a far field, including ellipses, parallelograms, etc.

Most optical assemblies for confining and transporting light from a light source have an aspect ratio near unity (e.g., 1:1). Linescanning sequencing systems, however, often use time and delay integration (TDI) imaging devices having a large aspect ratio (e.g., at least 8:1). While waveguides having aspect ratios up to 4:1 are available and can be used as collimators to form a substantially collimated beam, aspect ratios larger than this are not readily available. Shaped beams formed from the collimated beams generated by readily available collimators, accordingly, do not have an aspect ratio that matches the aspect ratio of a TDI imaging device.

An optical assembly for a linescanning sequencing system in various implementations herein accordingly includes an asymmetric beam expander group that includes one or more asymmetric elements or anamorphic elements disposed along an optical axis to asymmetrically or anamorphically expand a shaped beam. The shaped beam is formed from a collimated beam by a beam shaping group of the optical assembly, in some implementations. The asymmetric beam expander group magnifies or expands the width of the shaped beam and the height of the shaped beam by different amounts. That is, the asymmetric beam expander group expands or magnifies the shaped beam in the x-axis and y-axis by different amounts, where the z-axis is parallel to an optical axis of the optical assembly. The asymmetric beam expander group may, for example, magnify the shaped beam in the x-axis by an amount that is at least twice the amount of magnification in the y-axis. The shaped beam is, however, expanded in only one axis, in some implementations. The asymmetric beam expander group may include one or more pairs of crossed cylindrical lenses, one or more cylindrical telescopes, one or more anamorphic prisms, or one or more diffractive optical elements, in some implementations.

The asymmetric beam expander group is further selectively controllable in various implementations to switch the optical assembly between a high irradiance mode and a low irradiance mode to asymmetrically or anamorphically expand the shaped beam. The asymmetric beam expander group may include a lens or lens group.

The asymmetric beam expander group in still further implementations sweeps a shaped sampling beam across a sample to asymmetrically or anamorphically expand the shaped beam in a controllable way. The asymmetric beam expander group may include an actuator in such implementations to control an angle of a reflective element to sweep the sampling beam across the sample. The sampling beam may be swept across the sample during a sampling interval of an imaging device. The asymmetric beam expander group may further include one or more pairs of crossed cylindrical lenses, one or more cylindrical telescopes, one or more anamorphic prisms, or one or more diffractive elements to help form the sampling beam.

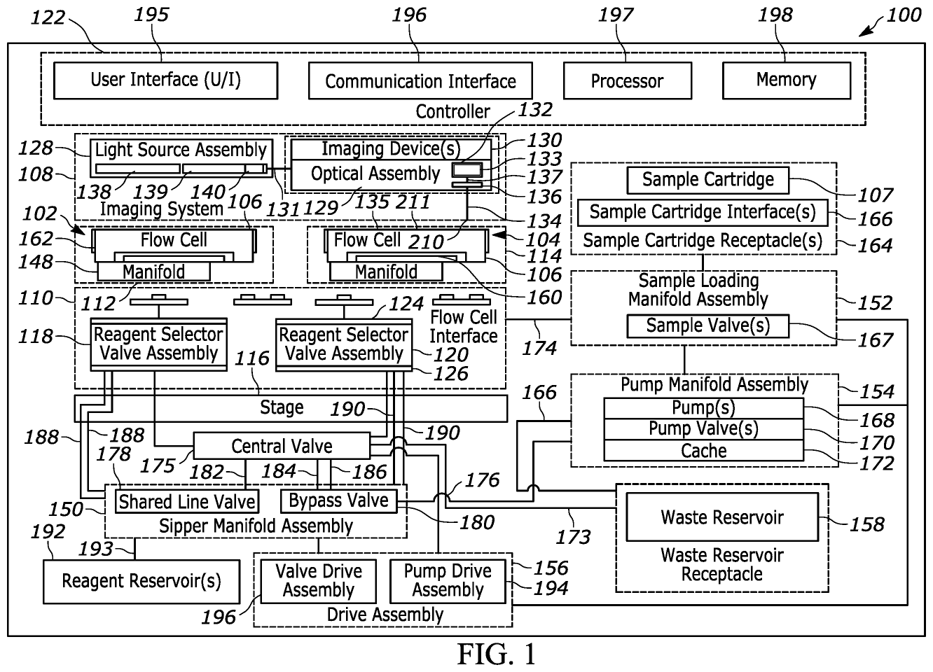

FIG. 1 illustrates a schematic diagram of an example implementation of a system 100 in accordance with teachings of the disclosure. The system 100 can be used to perform an analysis on one or more samples of interest. The one or more samples may include one or more DNA clusters that have been linearized to form a single stranded DNA (sstDNA). In the implementation shown, the system 100 is adapted to receive a pair of flow cell assemblies 102, 104 including corresponding flow cells 106. The system 100 includes, in part, one or more sample cartridges 107, an imaging system 108, and a flow cell interface 110 having flow cell receptacles 112, 114 that support corresponding flow cell assemblies 102, 104. The flow cell interface 110 may be associated with and/or referred to as a flow cell deck structure. The system 100 also includes a stage assembly 116, a pair of reagent selector valve assemblies 118, 120, and a controller 122. The reagent selector valve assemblies 118, 120 each include a reagent selector valve 124 and a valve drive assembly 126. The reagent selector valve assemblies 118, 120 may be referred to as mini-valve assemblies. The controller 122 is electrically and/or communicatively coupled to the imaging system 108, the reagent selector valve assemblies 118, 120, and the stage assembly 116, and is adapted to cause the imaging system 108, the reagent selector valve assemblies 118, 120, and the stage assembly 116 to perform various functions as disclosed herein.

The imaging system 108 of FIG. 1 includes a light source assembly 128, an optical assembly 129, and an imaging device 130 in the implementation shown. The imaging device 130 may be implemented as a scanner, a detector, a sensor, a camera, and/or a solid-state TDI line scanner. Other types of imaging devices 130 may prove suitable.

The optical assembly 129 includes an asymmetric beam expander group 132 that includes one or more asymmetric elements or anamorphic elements 133 disposed along an optical axis of the optical assembly 129 in the implementation shown. The light source assembly 128 forms a substantially collimated beam 131 of illumination. The optical assembly 129 receives the substantially collimated beam 131 in operation from the light source assembly 128 and transforms the substantially collimated beam 131 into a shaped sampling beam 134 having an elongated cross section 210 in a far field at or near a focal plane 135 of the optical assembly 129. The shaped sampling beam 134 can optically probe a sample 211 in the flow cell 106. The imaging device 130 obtains image data associated with the sample 211 in response to the optical probing of the sample 211 with the sampling beam 134.

The substantially collimated beam 131 has a first aspect ratio and the shaped sampling beam 134 has a second aspect ratio. The shaped sampling beam 134 as a result causes less damage to the sample 211 within the flow cell 106 and/or photobleaching. The first aspect ratio of the substantially collimated beam is at most 4:1 in some implementations and the second aspect ratio of the shaped sampling beam is at least 8:1. The first aspect ratio and/or the second aspect ratio may be different, however.

The asymmetric beam expander group 132 provides a first magnification in a first axis and a second different magnification in a second different axis. The first axis may be the x-axis and the second axis may be the y-axis. The asymmetric beam expander group 132 can thus transform high irradiance, elongated beams into a lower irradiance, broader beam as further discussed below. The first magnification can be at least twice the second magnification. The first magnification and/or the second magnification can be different ratios, however.

The optical assembly 129 also includes an objective group 136. The asymmetric beam expander group 132 asymmetrically or anamorphically expands the substantially collimated beam 131 having the first aspect ratio to form a shaped beam 137 having a second different aspect ratio. The objective group 136 is disposed along the optical axis and receives the shaped beam 137 from the asymmetric beam expander group 132 and transforms the shaped beam 137 into the elongated sampling beam 134 at or near the focal plane 135 of the optical assembly 129. The focal plane 135 of the optical assembly 129 may be the same as the focal plane of the objective group 136.

The asymmetric beam expander group 132 may magnify or expand the width of the shaped beam 137 and the height of the shaped beam 137 by different amounts. That is, the asymmetric beam expander group 132 can expand the shaped beam 137 in the x-axis and y-axis by different amounts. The z-axis is parallel to the optical axis of the optical assembly 129. The shaped beam 137 is expanded in only one axis, in some implementations.

The light source assembly 128 also includes a beam source 138 and a collimator 139 in the implementation shown. The beam source 138 provides input radiation in operation and the collimator 139 substantially collimates the input radiation from the beam source 138 to form the substantially collimated beam 131. The substantially collimated beam 131 can have a first aspect ratio.

The collimator 139 is shown including a waveguide 140 to do so having or associated with the first aspect ratio. The waveguide 140 can include a fiber such an optical fiber, a rectangular optical fiber, and/or a rigid light pipe having, or associated with, the first aspect ratio. The rectangular optical fiber may have an aspect ratio of 4:1. Other aspect ratios may prove suitable, however. The collimator 139 may also or alternatively include a spherical lens and/or an aspherical lens that is disposed to collimate an output of the waveguide 140. Other ways of forming the collimated beam 131 may prove suitable.

The system 100 of FIG. 1 also includes a sipper manifold assembly 150, a sample loading manifold assembly 152, a pump manifold assembly 154, a drive assembly 156, and a waste reservoir 158, in the implementation shown. The controller 122 is electrically and/or communicatively coupled to the sipper manifold assembly 150, the sample loading manifold assembly 152, the pump manifold assembly 154, and the drive assembly 156, and is adapted to cause the sipper manifold assembly 150, the sample loading manifold assembly 152, the pump manifold assembly 154, and the drive assembly 156 to perform various functions as disclosed herein.

Each of the flow cells 106, includes a plurality of channels 160 in the implementation shown. Each of the channels 160 has a first channel opening positioned at a first end of the flow cell 106 and a second channel opening positioned at a second end of the flow cell 106. Depending on the direction of flow through the channels 160, either of the channel openings may act as an inlet or an outlet. While the flow cells 106 are shown including two channels 160 in FIG. 1, any number of channels 160 may be included (e.g., 1, 2, 6, 8).

Each of the flow cell assemblies 102, 104 also includes a flow cell frame 162 and a flow cell manifold 148 coupled to the first end of the corresponding flow cell 106. As used herein, a flow cell (also referred to as a flowcell) can include a device having a lid extending over a reaction structure to form a flow channel therebetween that is in communication with a plurality of reaction sites of the reaction structure. Some flow cells may also include a detection device that detects designated reactions that occur at or proximate to the reaction sites. As shown, the flow cell 106, the flow cell manifold 148, and/or any associated gaskets used to establish a fluidic connection between the flow cell 106 and the system 100 are coupled or otherwise carried by the flow cell frame 162. While the flow cell frame 162 is shown included with the flow cell assemblies 102, 104 of FIG. 1, the flow cell frame 162 may be omitted. As such, the flow cell 106 and the associated flow cell manifold 148 and/or gaskets may be used with the system 100 without the flow cell frame 162.

It is noted that while some components of the system 100 of FIG. 1 are shown once and as being coupled to both of the flow cells 106, in some implementations, these components may be duplicated such that each flow cell 106 has its own corresponding components and the system 100 may include more than two flow cell receptacles 112, 114 and corresponding components. For example, each flow cell 106 may be associated with a separate sample cartridge 107, sample loading manifold assembly 152, pump manifold assembly 154, etc. In other implementations, the system 100 may include a single flow cell 106 and corresponding components.

The system 100 includes a sample cartridge receptacle 164 that receives the sample cartridge 107 that carries one or more samples of interest (e.g., an analyte). The system 100 also includes a sample cartridge interface 166 that establishes a fluidic connection with the sample cartridge 107.

The sample loading manifold assembly 152 includes one or more sample valves 167, and the pump manifold assembly 154 includes one or more pumps 168, one or more pump valves 170, and a cache 172. One or more of the valves 167, 170 may be implemented by a rotary valve, a pinch valve, a flat valve, a solenoid valve, a check valve, a piezo valve, and/or a three-way valve. Different types of fluid control devices may be used, however. One or more of the pumps 168 may be implemented by a syringe pump, a peristaltic pump, and/or a diaphragm pump. Other types of fluid transfer devices may be used, however. The cache 172 may be a serpentine cache and may temporarily store one or more reaction components during, for example, bypass manipulations of the system 100 of FIG. 1. While the cache 172 is shown being included in the pump manifold assembly 154, in another implementation, the cache 172 may be located in a different location. The cache 172, for example, may be included in the sipper manifold assembly 150 or in another manifold downstream of a bypass fluidic line 173.

The sample loading manifold assembly 152 and the pump manifold assembly 154 flow one or more samples of interest from the sample cartridge 107 through a fluidic line 174 toward the flow cell assemblies 102, 104, in the implementation shown. The sample loading manifold assembly 152 can individually load/address each channel 160 of the flow cells 106 with a sample of interest in some implementations. The process of loading the channels 160 of the flow cells 106 with a sample of interest may occur automatically using the system 100 of FIG. 1.

The sample cartridge 107 and the sample loading manifold assembly 152 are positioned downstream of the flow cell assemblies 102, 104 as shown in the system 100 of FIG. 1. The sample loading manifold assembly 152 may, thus, load a sample of interest into the flow cell(s) 106 from the rear of the flow cell(s) 106. Loading a sample of interest from the rear of the flow cell(s) 106 may be referred to as “back loading.” Back loading the sample of interest into the flow cell(s) 106 may reduce contamination. The sample loading manifold assembly 152 is coupled between the flow cell assemblies 102, 104 and the pump manifold assembly 154, in some implementations.

To draw a sample of interest from the sample cartridge 107 and toward the pump manifold assembly 154, the sample valves 167, the pump valves 170, and/or the pumps 168 may be selectively actuated to urge the sample of interest toward the pump manifold assembly 154. The sample cartridge 107 may include a plurality of sample reservoirs that are selectively fluidically accessible via the corresponding sample valve 167. Each sample reservoir can thus be selectively isolated from other sample reservoirs using the corresponding sample valves 167.

The sample valves 167, the pump valves 170, and/or the pumps 168 can be selectively actuated to urge the sample of interest toward the flow cell assembly 102 and into the respective channels 160 of the corresponding flow cell 106 to individually flow the sample of interest toward a corresponding channel of one of the flow cells 106 and away from the pump manifold assembly 154. Each channel 160 of the flow cell(s) 106 receives the sample of interest in some implementations. One or more of the channels 160 of the flow cell(s) 106 selectively receives the sample of interest and others of the channels 160 of the flow cell(s) 106 do not receive the sample of interest in other implementations. The channels 160 of the flow cell(s) 106 that may not receive the sample of interest may receive a wash buffer instead, for example.

The drive assembly 156 interfaces with the sipper manifold assembly 150 and the pump manifold assembly 154 to flow one or more reagents that interact with the sample within the corresponding flow cell(s) 106. A reversible terminator may be attached to the reagent to allow a single nucleotide to be incorporated onto a growing DNA strand. In some such implementations, one or more of the nucleotides has a unique fluorescent label that emits a color when excited. The color (or absence thereof) is used to detect the corresponding nucleotide. The imaging system 108 may excite one or more of the identifiable labels (e.g., a fluorescent label) and thereafter obtains image data using the imaging device 130 for the identifiable labels, in the implementation shown. The labels may be excited by incident light and/or a laser and the image data may include one or more colors emitted by the respective labels in response to the excitation. The image data (e.g., detection data) may be analyzed by the system 100. The imaging system 108 may be a fluorescence spectrophotometer including an objective lens and/or the imaging device 130. The imaging device 130 may include a charge coupled device (CCD) and/or a complementary metal oxide semiconductor (CMOS) device. However, other types of imaging systems 108 and/or optical instruments may be used. For example, the imaging system 108 may be or be associated with a scanning electron microscope, a transmission electron microscope, an imaging flow cytometer, high-resolution optical microscopy, confocal microscopy, epifluorescence microscopy, two photon microscopy, differential interference contrast microscopy, etc.

After the image data is obtained, the drive assembly 156 interfaces with the sipper manifold assembly 150 and the pump manifold assembly 154 to flow another reaction component (e.g., a reagent) through the flow cell(s) 106 that is thereafter received by the waste reservoir 158 via a primary waste fluidic line 166 and/or otherwise exhausted by the system 100. Some reaction components perform a flushing operation that chemically cleaves the fluorescent label and the reversible terminator from the sstDNA. The sstDNA is then ready for another cycle.

The primary waste fluidic line 166 is coupled between the pump manifold assembly 154 and the waste reservoir 158. The pumps 168 and/or the pump valves 170 of the pump manifold assembly 154 may selectively flow the reaction components from the flow cell assembly 102, 104, through the fluidic line 174 and the sample loading manifold assembly 152 to the primary waste fluidic line 166.

The flow cell assemblies 102, 104 are coupled to a central valve 175 via the flow cell interface 110. An auxiliary waste fluidic line 173 is coupled to the central valve 175 and to the waste reservoir 158. The auxiliary waste fluidic line 173 receives excess fluid of a sample of interest from the flow cell assembly 102, 104, via the central valve 175, in some implementations and flows the excess fluid of the sample of interest to the waste reservoir 158 when back loading the sample of interest into the flow cell(s) 106, as described herein. That is, the sample of interest may be loaded from the rear of the flow cell(s) 106 and any excess fluid for the sample of interest may exit from the front of the flow cell(s) 106. Different samples can be separately loaded to corresponding channels 160 of the corresponding flow cell(s) 106 by back loading samples of interest into the flow cell(s) 106 and the single flow cell manifold 148 can couple the front of the flow cell(s) 106 to the central valve 175 to direct excess fluid of each sample of interest to the auxiliary waste fluidic line 173. Once the samples of interest are loaded into the flow cell(s) 106, the flow cell manifold 148 can be used to deliver common reagents from the front of the flow cell(s) 106 (e.g., upstream) for each channel 160 of the flow cell(s) 106 that exit from the rear of the flow cell(s) 106 (e.g., downstream). Put another way, the sample of interest and the reagents may flow in opposite directions through the channels 160 of the flow cell(s) 106.

The sipper manifold assembly 150 includes a shared line valve 178 and a bypass valve 180, in the implementation shown. The shared line valve 178 may be referred to as a reagent selector valve. The reagent selector valves 124 of the reagent selector valve assemblies 118, 120, the central valve 175 and/or the valves 178, 180 of the sipper manifold assembly 150 may be selectively actuated to control the flow of fluid through fluidic lines 182, 184, 186, 188, 190. One or more of the valves 124, 170, 175, 178, 180 may be implemented by a rotary valve, a pinch valve, a flat valve, a solenoid valve, a check valve, a piezo valve, etc. Other fluid control devices may prove suitable.

The sipper manifold assembly 150 may be coupled to a corresponding number of reagents reservoirs 192 via reagent sippers 193. The reagent reservoirs 192 may contain fluid (e.g., reagent and/or another reaction component). The sipper manifold assembly 150 may include a plurality of ports. Each port of the sipper manifold assembly 150 may receive one of the reagent sippers 193. The reagent sippers 193 may be referred to as fluidic lines.

The shared line valve 178 of the sipper manifold assembly 150 is coupled to the central valve 175 via the shared reagent fluidic line 182. Different reagents may flow through the shared reagent fluidic line 182 at different times. When performing a flushing operation before changing between one reagent and another, the pump manifold assembly 154 may draw wash buffer through the shared reagent fluidic line 182, the central valve 175, and the corresponding flow cell assembly 102, 104. The shared reagent fluidic line 182 may, thus, be involved in the flushing operation. While one shared reagent fluidic line 182 is shown, any number of shared fluidic lines may be included in the system 100.

The bypass valve 180 of the sipper manifold assembly 150 is coupled to the central valve 175 via the reagent fluidic lines 184, 186. The central valve 175 may have one or more ports that correspond to the reagent fluidic lines 184, 186.

The dedicated fluidic lines 188, 190 are coupled between the sipper manifold assembly 150 and the reagent selector valve assemblies 118, 120. Each of the dedicated reagent fluidic lines 188, 190 may be associated with a single reagent. The fluids that may flow through the dedicated reagent fluidic lines 188, 190 may be used during sequencing operations and may include a cleave reagent, an incorporation reagent, a scan reagent, a cleave wash, and/or a wash buffer. The dedicated reagent fluidic lines 188, 190 themselves may not be flushed when performing a flushing operation before changing between one reagent and another because only a single reagent may flow through each of the dedicated reagent fluidic lines 188, 190. The approach of including dedicated reagent fluidic lines 188, 190 may be advantageous when the system 100 uses reagents that may have adverse reactions with other reagents. Moreover, reducing a number of fluidic lines or length of the fluidic lines that are flushed when changing between different reagents reduces reagent consumption and flush volume and may decrease cycle times of the system 100. While four dedicated reagent fluidic lines 188, 190 are shown, any number of dedicated fluidic lines may be included in the system 100.

The bypass valve 180 is also coupled to the cache 172 of the pump manifold assembly 154 via the bypass fluidic line 176. One or more reagent priming operations, hydration operations, mixing operations, and/or transfer operations may be performed using the bypass fluidic line 176. The priming operations, the hydration operations, the mixing operations, and/or the transfer operations may be performed independent of the flow cell assembly 102, 104. The operations using the bypass fluidic line 176 may, thus, occur during, for example, incubation of one or more samples of interest within the flow cell assembly 102, 104. That is, the shared line valve 178 can be utilized independently of the bypass valve 180 such that the bypass valve 180 can utilize the bypass fluidic line 176 and/or the cache 172 to perform one or more operations while the shared line valve 178 and/or the central valve 175 simultaneously, substantially simultaneously, or offset synchronously perform other operations. The system 100 can, thus, perform multiple operations at once, thereby reducing run time.

The drive assembly 156 includes a pump drive assembly 194 and a valve drive assembly 196, in the implementation shown. The pump drive assembly 194 may be adapted to interface with the one or more pumps 168 to pump fluid through the flow cell 106 and/or to load one or more samples of interest into the flow cell 106. The valve drive assembly 196 may be adapted to interface with one or more of the valves 167, 170, 175, 178, 180 to control the position of the corresponding valves 167, 170, 175, 178, 180.

The controller 122, in the implementation shown, includes a user interface 195, a communication interface 196, one or more processors 197, and a memory 198 storing machine-readable instructions executable by the one or more processors 197 to perform various functions including the disclosed implementations. The user interface 195, the communication interface 196, and the memory 198 are electrically and/or communicatively coupled to the one or more processors 197.

The user interface 195 may be adapted to receive input from a user and to provide information to the user associated with the operation of the system 100 and/or an analysis taking place. The user interface 195 may include a touch screen, a display, a keyboard, a speaker(s), a mouse, a track ball, and/or a voice recognition system. The touch screen and/or the display may display a graphical user interface (GUI).

The communication interface 196 may be adapted to enable communication between the system 100 and remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 197 and/or the system 100 may include one or more of a processor-based system(s) or a microprocessor-based system(s). In some implementations, the one or more processors 197 and/or the system 100 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

The memory 198 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache and/or any other storage device or storage disk in which information is stored for any duration (e.g., permanently, temporarily, for extended periods of time, for buffering, for caching).

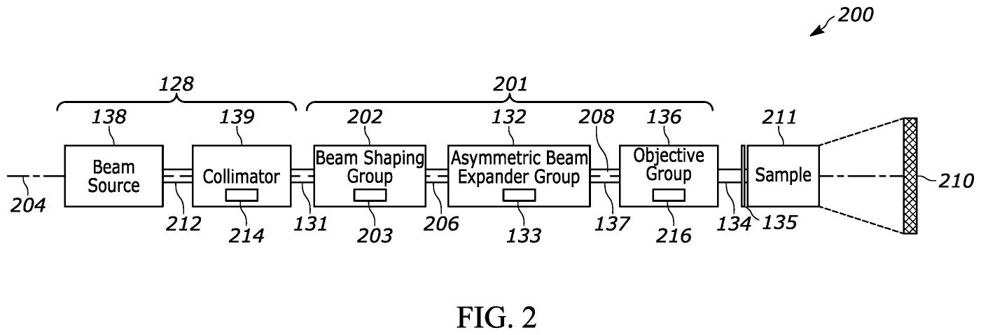

FIG. 2 is a schematic diagram of a portion an example imaging system 200 that can be used to implement the imaging system 108 of FIG. 1. The imaging system 200 is similar to the imaging system 108 of FIG. 1 in that the imaging system 200 of FIG. 2 includes the beam source 138, the collimator 139, the asymmetric beam expander group 132, and the objective group 136. The imaging system 200 of FIG. 2 in contrast, however, includes an optical assembly 201 having a beam shaping group 202 that has one or more optical elements 203. The optical elements 203 are disposed along an optical axis 204 of the optical assembly 201 and receive the substantially collimated beam 131 from the collimator 139. The beam shaping group 202 transforms the substantially collimated beam 131 into a first shaped beam 206 having a first aspect ratio.

The asymmetric beam expander group 132 receives the first shaped beam 206 in the implementation shown and asymmetrically or anamorphically expands the first shaped beam 206 to form a second shaped beam 208 having a second different aspect ratio. The shaped beam 137 and the second shaped beam 208 may be the same or substantially the same. The asymmetric beam expander group 132 magnifies or expands the width of the first shaped beam 206 and the height of the first shaped beam 206 by different amounts. That is, the asymmetric beam expander group 132 expands or magnifies the first shaped beam 206 in the x-axis and in the y-axis by different amounts. The z-axis is parallel to the optical axis 204. The objective group 136 is disposed along the optical axis 204 and receives the second shaped beam 208 from the asymmetric beam expander group 132. The objective group 136 transforms the second shaped beam 208 into the elongated sampling beam 134 at or near the focal plane 135 of the optical assembly 129.

The imaging system 200 is generally configured to form the sampling beam 134 having the elongated cross section 210 on the sample 211 in the flow cell 106 of FIG. 1 or on another substrate. The example elongated cross section 210 is substantially rectangular in the implementation shown. Other cross-sections may prove suitable, however. The sample 211 being exposed to the shaped sampling beam 134 causes the sample 211 to fluoresce. The imaging device 130 of FIG. 1 can detect, sense, and/or image florescent illumination and/or radiation emitted by the sample 211.

The light source assembly 128 includes the beam source 138 that generates an input beam 212 and the collimator 139 that is positioned to receive the input beam 212. The input beam 212 may be referred to as input radiation. The collimator 139 and the beam source 138 are shown disposed along the optical axis 204 of the imaging system 200.

The beam source 138 may be implemented using any number and/or type(s) of lasers, laser diodes, diode-pumped solid-state lasers, coherent light sources, light emitting diodes, black body sources, optical amplifiers, filters, and/or amplifier stages. The beam source 138 may be implemented in different ways, however. The beam source 138 emits light in the blue region of visible light, in some implementations. The beam source 138 can emit light in the ultraviolet spectrum or another spectrum for exciting fluorescence from a probed sample in other implementations. While described often herein as a beam, the light or beam may additionally be referred to as radiation or illumination. While described herein as being a single beam and a single beam source 138, multiple beam sources may provide multiple beams individually, in a pulsed interleaved manner, or simultaneously to the elements of the systems and apparatuses described herein.

The collimator 139 is disposed along the optical axis 204 between the beam source 138 and the beam shaping group 202 in the implementation shown and receives the input beam 212 from the beam source 138. The collimator 139 generates the substantially collimated beam 131 from the input beam 212. The collimator 139 may include one or more optical elements 214.

The beam shaping group 202 formats the substantially collimated beam 131 into the first shaped beam 206 having an elongated cross section according to a first aspect ratio. The beam shaping group 202 may include any number and/or type(s) of optical elements 203 disposed along the optical axis 204.

The optical elements 203 of the beam shaping group 202 may include focusing surfaces, lenses, reflective surfaces, or mirrors, diffractive elements, filters, polarizers, waveplates, apertures, spatial light modulators, and/or microlens arrays. The beam shaping group 202 may include a Powell lens, a beam shaping lens, diffractive elements, and/or scattering elements. While the asymmetric beam expander group 132 is shown separately from the beam shaping group 202 and following the beam shaping group 202, the beam shaping group 202 and the asymmetric beam expander group 132 may be implemented differently. The asymmetric beam expander group 132 may precede the beam shaping group 202 or may be integrated into the beam shaping group 202, for example. The beam shaping group 202 may alternatively be omitted.

The objective group 136 has one or more optical elements 216 and is disposed along the optical axis 204. The objective group 136 can focus the second shaped beam 208 so that the shaped sampling beam 134 is propagated toward and focused on the sample 211, for example. The objective group 136 can have the focal plane 135 that may be at the sample 211, in a region of the sample 211, in a region along the optical axis 204 upstream of the sample 211, or in a region along the optical axis 204. The imaging device 130 may be in a different location than shown, however.

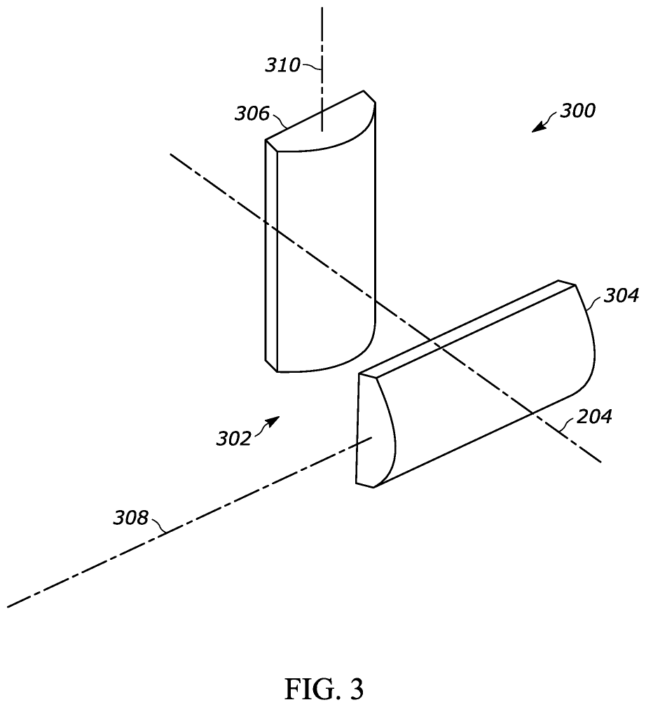

FIG. 3 is a schematic diagram of an example asymmetric beam expander group 300 that can be used to implement the asymmetric beam expander group 132 of FIG. 1 or 2. The asymmetric beam expander group 300 asymmetrically or anamorphically expands or magnifies a beam, such as the substantially collimated beam 131 and/or the first shaped beam 206. The asymmetric beam expander group 300 of FIG. 3 includes a pair 302 of cylindrical lenses 304 and 306 disposed along the optical axis 204. The cylindrical lenses 304, 306 may have different powers and are shown being oriented on different axes 308, 310. A longitudinal axis of the cylindrical lens 304 is shown aligned with the axis 308 and a longitudinal axis of the cylindrical lens 306 is shown aligned with the axis 310. The axis 308 may be and/or, be parallel, to the x-axis, the axis 310 may be and/or, be parallel, to the y-axis, and the optical axis 204 may be and/or, be parallel, to the z-axis. The cylindrical lenses 304, 306 of FIG. 3 are arranged perpendicular to each other, with the cylindrical lens 304 being parallel with the x-axis 308 and the cylindrical lens 306 being parallel with the y-axis 310. One of the cylindrical lenses 304, 306 may have twice the power, magnification, or effective focal length of the other cylindrical lens 304, 306. The asymmetric beam expander group 300 and the beam shaping group 202 of FIG. 2 can be used to generate the sampling beam 134 having a larger aspect ratio.

The cylindrical lenses 304, 306 may alternatively be crossed such that the cylindrical lenses 304, 306 are aligned at different angles relative to the x-axis and/or the y-axis of the asymmetric beam expander group 300. The cylindrical lenses 304, 306 can expand a beam along a different axis by different amounts when the cylindrical lenses 304, 306 are crossed and have different powers. Multiple cylindrical lenses aligned to the same axis may be implemented to provide additional magnification along a particular axis. The cylindrical lenses 304 and/or 306 can expand the first shaped beam 206 differently along the different axes 308, 310 such as the x-axis and/or the y-axis. While FIG. 3 shows two of the lenses 304, 306 being provided, more than one pair 302 of the crossed cylindrical lenses 304, 306 or any number of the lenses 304, 306 may be included in series and/or one cylindrical lens may be included. A single cylindrical lens 304 and/or 306 and/or multiple aligned cylindrical lens 304, 306 may also expand the first shaped beam 206 differently along different axes such as the x-axis and/or the y-axis.

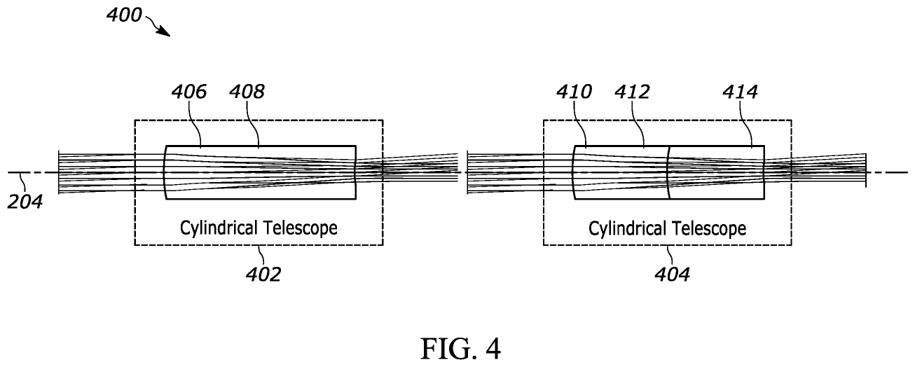

FIG. 4 is a schematic diagram of another example asymmetric beam expander group 400 that can be used to implement the asymmetric beam expander group 132 of FIGS. 1 and/or 2. The asymmetric beam expander group 400 asymmetrically or anamorphically expands or magnifies a beam, such as the substantially collimated beam 131 or the first shaped beam 206. The asymmetric beam expander group 400 of FIG. 4 includes a pair of cylindrical telescopes 402 and 404 disposed on the optical axis 204. Another number of cylindrical telescopes 402, 404 may be used, however.

The first cylindrical telescope 402 includes a singlet lens 406 including a single lens 408 and the second cylindrical telescope 404 includes a doublet lens 410 including a pair of lenses 412, 414 in the implementation shown. However, other combinations of singlet lenses and/or doublet lenses may be implemented in other implementations. The doublet lens 410 may be an afocal doublet and may be achromatic. The lenses 412, 414 of the doublet lens 410 may alternatively be spaced to provide an air gap between the lenses 412, 414. The air gap between the lenses 412, 414 reduces a distance that light passes through the lenses 410, 412 and a likelihood that the lenses 412, 414 absorb heat. The cylindrical telescopes 402, 404 can be in series, nested, or interleaved. The cylindrical telescopes 402, 404 may be a Keplerian telescope, a Galilean telescope, and/or a hybrid Keplerian-Galilean telescope, in some implementations. The cylindrical telescopes 402, 404 may magnify the beam 131 and/or 206 by different amounts along different axes such as the along the x-axis and/or the y-axis. One of the cylindrical telescopes 402, 404 can anamorphically expand the beam 131 and/or 206 by a factor of two (2) along one axis, for example.

The asymmetric beam expander group 400 and the beam shaping group 202 of FIG. 2 can be used to generate the sampling beam 134 having a larger aspect ratio. While FIG. 4 shows two of the cylindrical telescopes 402, 404 being provided, more than two of the cylindrical telescopes may be provided and aligned relative to the axis 204 and/or one cylindrical telescope may be included, for example.

The cylindrical telescopes 402, 404 may alternatively be crossed such that the cylindrical telescopes 402, 404 are aligned at different angles relative to the x-axis and/or the y-axis of the asymmetric beam expander group 400. The z-axis of the asymmetric beam expander group 400 may be parallel to the optical axis 204. The cylindrical telescopes 402, 404 can each expand a beam along a different axis by different amounts when the cylindrical telescopes 402, 404 are crossed and have different powers.

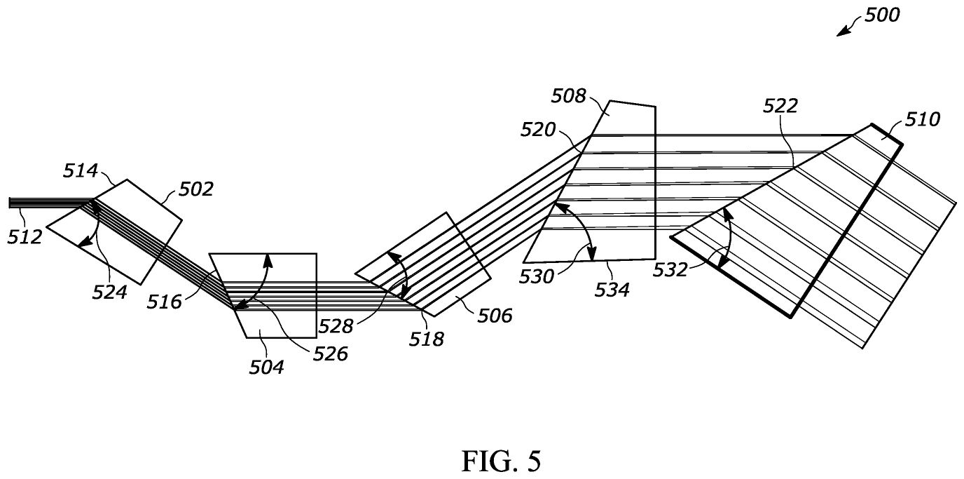

FIG. 5 is a schematic diagram of another example asymmetric beam expander group 500 that can be used to implement the asymmetric beam expander group 132 of FIGS. 1 and/or 2. The asymmetric beam expander group 500 asymmetrically or anamorphically expands or magnifies a beam, such as the substantially collimated beam 131 or the first shaped beam 206. The asymmetric beam expander group 500 of FIG. 5 includes a plurality of anamorphic prisms 502, 504, 506, 508, and 510. The prisms 502, 504, 506, 508, and 510 are disposed along the optical axis 204 in the implementation shown such that magnification is provided in substantially only one axis such as the x-axis or the y-axis. The beam 512 may be, or be associated with, the collimated beam 131 from the light source assembly 128 and/or the first shaped beam 206 from the beam shaping group 202. Each of the prisms 502, 504, 506, 508, and 510 asymmetrically or anamorphically expands or magnifies a beam 512 in only one axis as a result. Put another way, the prisms 502, 504, 506, 508, and 510 expand the beam 512 along one axis such as the x-axis and do not expand the beam 512 along another axis such as the y-axis or the z-axis.

The series of anamorphic prisms 502, 504, 506, 508, and 510 may be implemented to successively expand or magnify the beam 512 shown in FIG. 5. The prisms 502, 504, 506, 508, and 510 may be made of the same material or different materials. The prisms 502, 504, 506, 508, and 510 may each be made of the same glass such as N-SF11, for example. One or more of the prisms 502, 504, 506, 508, and 510 may alternatively be made of a first glass such as N-BK7 and one or more others of the prism 502, 504, 506, 508, and 510 may be made of a second glass such as N-FK56, for example. The first prism 502 may thus include a first glass type and the second prism 504 may include a second glass type. The material choices for the anamorphic prisms 502, 504, 506, 508, and 510 may allow dispersion caused by earlier ones of the prisms 502, 504, 506, 508, and 510 to be compensated for by later ones of the prims 502, 504, 506, 508, and 510 in the asymmetric beam expander group 500.

While five anamorphic prisms 502, 504, 506, 508, and 510 are shown, fewer or more anamorphic prisms can be included with the asymmetric beam expander group 500 in other implementations. The beam shaping group 202 having a first aspect ratio can be used to generate the shaped sampling beam 134 having a larger aspect ratio when the asymmetric beam expander group 500 is used in the imaging systems 108, 200 in some implementations.

The prisms 502, 504, 506, 508, and 510 have surfaces 514, 516, 518, 520, and 522 that define angles 524, 526, 528, 530, 532 relative to a corresponding base 534 of the prisms 502, 504, 506, 508, 510 that are the same or substantially the same. As set forth herein, substantially the same means having angles of about +/−2° of one another or accounts for manufacturing tolerances. The surfaces 514, 516, 518, 520, 522 may be referred to as incident faces. One or more of the angles 524, 526, 528, 530, 532 may be different, however.

The beam 512 propagates through the prisms 502, 504, 506, 508, and 510 in operation and strikes the surfaces 514, 516, 518, 520, 522 of each of the prism 502, 504, 506, 508, and 510 at the same angle or at approximately the same angle in the implementation shown. The beam 512 may strike the surfaces 514, 516, 518, 520, 522 of each of the prisms 502, 504, 506, 508, and 510 at a corresponding Brewster's angle to reduce optical loss. The beam 512 may strike the prisms 502, 504, 506, 508, and 510 at different angles, however. The surfaces 514, 516, 518, 520, 522 of one or more of the prisms 502, 504, 506, 508, and 510 may be coated with an anti-reflection coating.

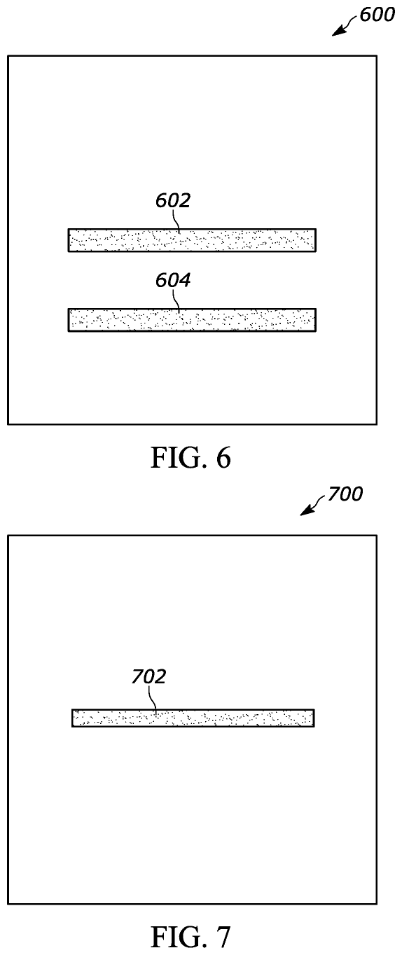

FIG. 6 shows an example pattern of illumination 600 generated using the asymmetric beam expander group 500 of FIG. 5 when each of the prisms 502, 504, 506, 508, and 510 are formed of the same type of glass. The pattern of illumination 600 of FIG. 6 includes two lines 602, 604, where one of the lines 602, 604 corresponds to blue light and the other of the lines 602, 604 corresponds to green light.

The pattern of illumination 600 may be generated by passing the beam 512 of FIG. 5 through the anamorphic prisms 502, 504, 506, 508, and 510 and the anamorphic prisms 502, 504, 506, 508, and 510 separating the beam 512 into its corresponding component colors, referred to as dispersion. The different colors of light will form respective separate patterns of illumination at respective different locations in a far field, when the prisms 502, 504, 506, 508, and 510 are formed of the same type of glass, in some implementations.

FIG. 7 shows an example pattern of illumination 700 generated using the asymmetric beam expander group 500 of FIG. 5 when the prisms 502, 504, 506, 508, and 510 are formed of two or more types of glass. The pattern of illumination 700 of FIG. 7 includes one line 702 having higher irradiance and including all of the colors of the beam 512. The lines 602, 604 of FIG. 6 may overlay each other and form the line 702 in FIG. 7. The prisms 502, 504, 506, 508, and 510 used to form the pattern of illumination 700 of FIG. 7 allow the different colors of light to collectively overlap and form a single area of high irradiance shown as the line 702 in a far field. The different colors of light overlap even if they diverge within the asymmetric beam expander group 500. The prisms 502, 504, 506, 508, and 510 having the different material types can, thus, allow at least two wavelengths of light to diverge and then overlap at the focal plane 135.

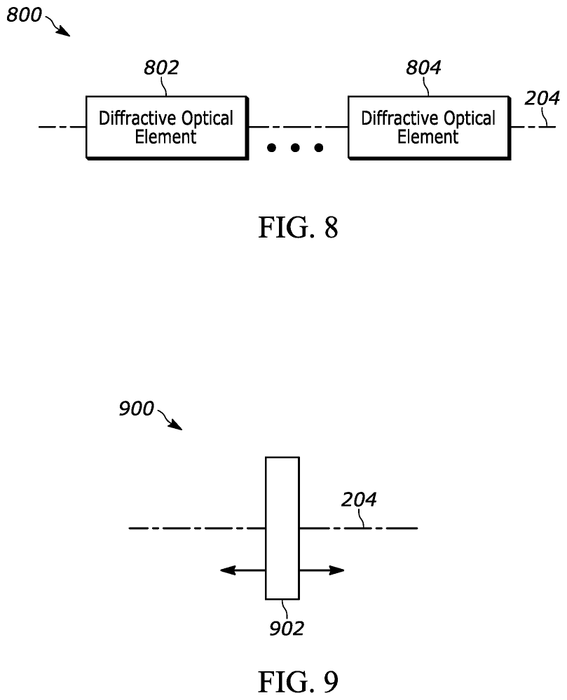

FIG. 8 is a schematic diagram of a still further example asymmetric beam expander group 800 that can be used to implement the asymmetric beam expander group 132 of FIGS. 1 and/or 2. The asymmetric beam expander group 800 asymmetrically or anamorphically expands or magnifies a beam, such as the substantially collimated beam 131 and/or the first shaped beam 206. The asymmetric beam expander group 800 of FIG. 8 includes diffractive elements 802 and 804 disposed along the optical axis 204. The diffractive elements 802, 804 may be referred to as diffractive optical elements and may configured to perform one-dimensional (1D) shaping.

The diffractive elements 802, 804 shape the collimated beam 131 and/or the first shaped beam 206 in one axis by causing divergence of the beam 131 and/or 206 in only one axis, for example. The diffractive elements 802, 804 may include a refractive homogenizer, a refractive diffuser, and/or a cylindrical microlens array. The diffractive element 802, 804 may be a diffuser engineered to have a substantially or pseudo-random, non-periodic surface such that a resulting beam has a substantially uniform, flat-top illumination profile in some implementations. While two diffractive elements 802, 804 are shown in FIG. 8, fewer or more optical elements can be included with the asymmetric beam expander group 800 in other implementations.

FIG. 9 is a schematic diagram of another example asymmetric beam expander group 900 that can be used to implement the asymmetric beam expander group 132 of FIGS. 1 and/or 2. The asymmetric beam expander group 900 asymmetrically or anamorphically expands or magnifies a beam, such as the substantially collimated beam 131 or the first shaped beam 206. The asymmetric beam expander group 900 of FIG. 9 includes a lens 902 disposed along the optical axis 204. The lens 902 may include a lens group.

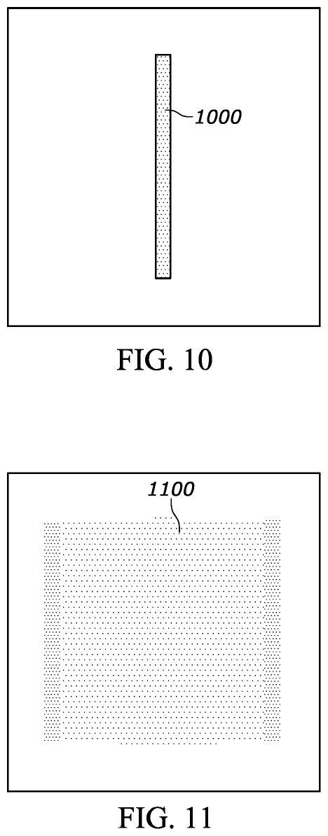

The imaging system 108, 200 or an associated actuator can move the lens 902 along the optical axis 204 in operation to switch the asymmetric beam expander group 900 between a high irradiance mode and a low irradiance mode. The imaging system 108, 200 can selectively position the lens 902 along the optical axis 204. That is, the imaging system 108, 200 can selectively move the lens 902 forward and backward along the optical axis 204 between a first position associated with the high irradiance mode and a second position associated with the low irradiance mode. The high irradiance mode is associated with the asymmetric beam expander 900 generating a high irradiance, elongated beam pattern 1000 shown in FIG. 10 and the low irradiance mode is associated with the asymmetric beam expander 900 generating a low irradiance, broader beam pattern 1100 shown in FIG. 11.

The asymmetric beam expander group 900 can, thus, be used to selectively asymmetrically or anamorphically expand the shape of the sampling beam 134 differently along different axes such as the x-axis and/or the y-axis. The asymmetric beam expander group 900 of FIG. 9 may include and/or be used in conjunction with any of the asymmetric beam expander groups 132, 300, 400, 500, and 800. The asymmetric beam expander group 132, 300, 400, 500, 800 may, thus, use asymmetric magnification to form a high irradiance, elongated beam that the asymmetric beam expander group 900 receives and transforms into a lower irradiance, broader beam.

FIG. 10 shows the high irradiance, elongated beam pattern 1000 generated with the asymmetric beam expander group 900 of FIG. 9 being in a first position.

FIG. 11 shows a low irradiance, broader beam pattern 1100 generated with the asymmetric beam expander group 900 of FIG. 9 being in a second position.

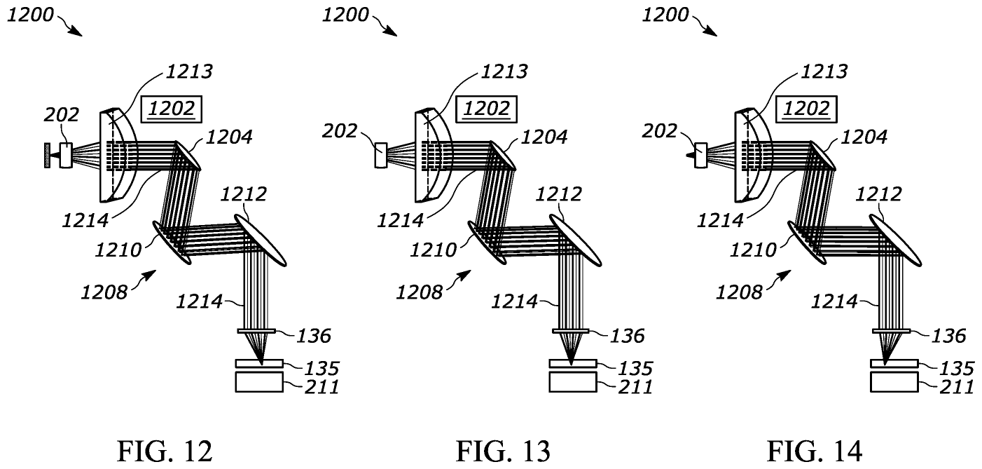

FIG. 12 is a schematic diagram of another asymmetric beam expander group 1200 that can used to implement the asymmetric beam expander group 132 of FIGS. 1 and/or 2.

The asymmetric beam expander group 1200 includes an actuator 1202, a reflective element 1204, an optical dogleg 1208 having reflective elements 1210, 1212, and the objective group 136. The asymmetric beam expander group 1200 may also include a cylindrical lens 1213 or any of the asymmetric beam expander groups 300, 400, 500, 800 to allow the magnification in each direction to be independently controlled such as along the x-axis and/or along the y-axis. The actuator 1202 may be a servo, galvanometer, or any other actuator and the reflective elements 1204, 1210, and 1212 may be mirrors. While the asymmetric beam expander group 1200 is shown including three reflective elements 1204, 1210, 1212, the asymmetric beam expander group 1200 may include more or fewer reflective elements.

Use of a high irradiance sampling beam having an elongated cross section (e.g., generated as described above in connection with FIGS. 2, 3, 4, and 8) can be informative to photo-induced damage to absorbing molecules or DNA via energy transfer. An imaging device with a lower aspect ratio (e.g., 1:1) is sometimes implemented, however, that illuminates the full field of view of the imaging device.

The asymmetric beam expander group 1200 receives a beam 1214 in operation and the actuator 1202 redirects the beam 1214. The objective group 136 may focus the beam 1214 at the focal plane 135 of the sample 211. The reflective element 1204 in FIG. 12 is angled at about 39 degrees relative to an optical axis of the asymmetric beam expander group 1200. The actuator 1202 can position the reflective element 1204 to be tilted at any other angle, however. The beam 1214 may be, or may be associated with, the collimated beam 131 and/or the first shaped beam 206. The asymmetric beam expander group 1200 of FIG. 12 can sweep the shaped beam 137, 208 having a high irradiance, elongated cross section generated using one of the asymmetric beam expander groups 300, 400, 500, 800 so that the shaped sampling beam 134 sweeps across the sample 211. The asymmetric beam expander group 1200 may sweep the sampling beam within the exposure time of the imaging device 130, in some implementations.

One or more of the asymmetric beam expander groups 300, 400, 500, 800 can form the beam 1214 to have an elongated, substantially rectangular cross section of in some implementations. Illuminating the full field of view of such an imaging device may reduce the irradiance of the sampling beam.

FIG. 13 is a schematic diagram of the asymmetric beam expander group 1200 of FIG. 12 showing the reflective element 1204 in a second position. The reflective element 1204 is angled at about 40 degrees relative to the optical axis of the asymmetric beam expander group 1200 in the implementation shown.

FIG. 14 is a schematic diagram of the asymmetric beam expander group 1200 of FIG. 12 showing the reflective element 1204 in a third position. The reflective element 1204 is angled at about 41 degrees relative to the optical axis of the asymmetric beam expander group 1200 in the implementation shown.

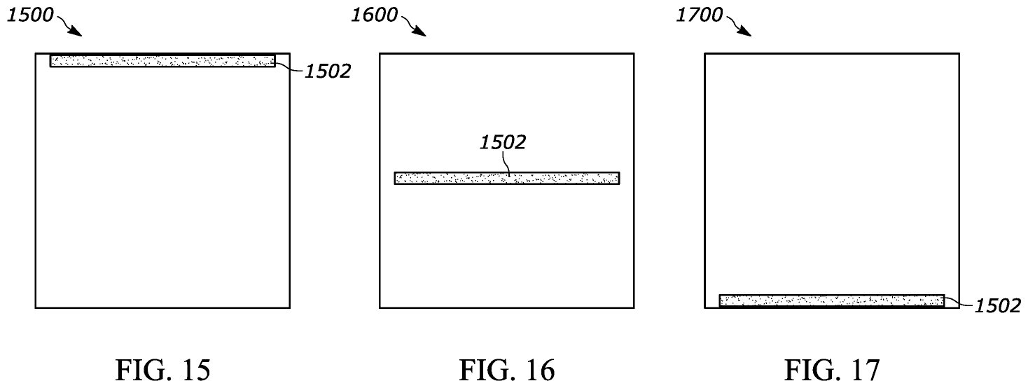

FIG. 15 shows a pattern of illumination 1500 showing a sampling beam 1502 generated using the asymmetric beam expander group 1200 of FIG. 12 with the reflective element 1204 in a first position. The sampling beam 1502 is shown at approximately a top of the pattern of illumination 1500 of FIG. 15. Changing the angle of the reflective element 1204 may also change the location of the sampling beam 1502 in a field of view of the imaging device 130, for example.

FIG. 16 shows a pattern of illumination 1600 showing the sampling beam 1502 generated using the asymmetric beam expander group 1200 of FIG. 13 with the reflective element 1204 in a second position. The sampling beam 1502 is shown at approximately the middle of the pattern of illumination 1600, in the implementation shown.

FIG. 17 shows a pattern of illumination 1700 showing the sampling beam 1502 generated using the asymmetric beam expander group 1200 of FIG. 14 with the reflective element 1204 in the third position. The sampling beam 1502 is shown at approximately the bottom of the pattern of illumination 1600.

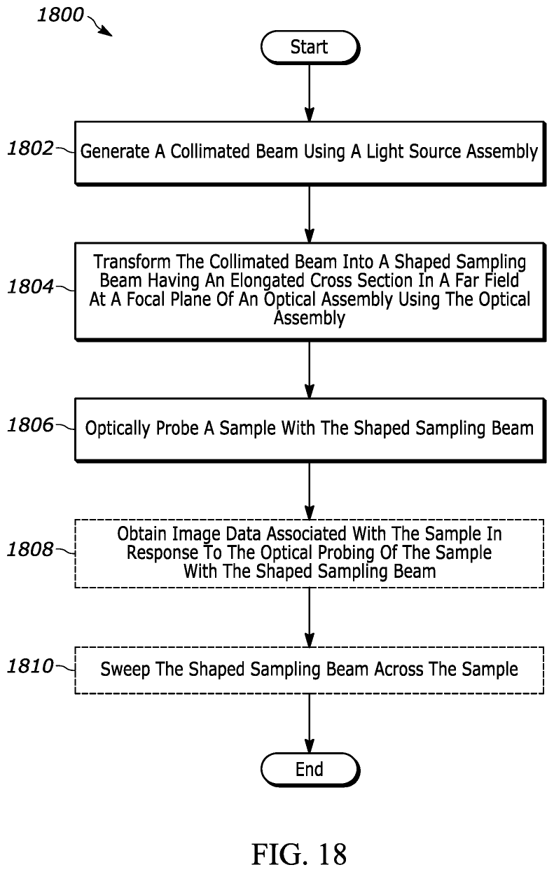

FIG. 18 is a flowchart of an example process 1800 of using the system 100 of FIG. 1, the imaging system 108, 200 of FIGS. 1 and 2, the optical assemblies 129, 201 of FIGS. 1 and 2, and/or the asymmetric beam expander groups 132, 300, 400, 500, 900, 1200 of FIGS. 1, 2, 3, 4, 5, 8, 9, 12. In the flow chart of FIG. 18, the blocks surrounded by solid lines may be included in an implementation of the process 1800 while the blocks surrounded in dashed lines may be optional in the implementation of the process. Regardless of the way the border of the blocks are presented in FIG. 18 however, the order of execution of the blocks may be changed, and/or some of the blocks described may be changed, eliminated, combined, and/or subdivided into multiple blocks.

The process 1800 of FIG. 18 begins with the light source assembly 128 generating the collimated beam 131 (Block 1802). The collimated beam 131 can be generated by passing the input beam 212 through the waveguide 140, in some implementations. The waveguide 140 may include at least one of a rectangular optical fiber or a light pipe. The optical fiber may have another cross-section, however, and other types of waveguides 140 may prove suitable.

The collimated beam 131 is transformed into the shaped sampling beam 134 having the elongated cross section 210 in a far field at the focal plane 135 of the optical assembly 129 using the optical assembly 129, 201 (Block 1804). The optical assembly 129, 201 includes the asymmetric beam expander group 132, 300, 400, 800, 900, 1200 that includes one or more asymmetric elements or anamorphic elements 133 disposed along the optical axis 204.

The collimated beam 131 is transformed into the shaped sampling beam 134 in some implementations by asymmetrically or anamorphically expanding the substantially collimated beam 131 having a first aspect ratio using the asymmetric beam expander group 132, 300, 400, 800, 900, 1200 to form the shaped beam 137, 208 having a second aspect ratio. The collimated beam 131 is transformed into the shaped sampling beam 134 in some implementations by transforming the shaped beam 137, 208 into the shaped sampling beam 134 at or near the focal plane 135 of the optical assembly 129, 201 using the objective group 136 disposed along the optical axis 204. The substantially collimated beam 131 can be asymmetrically or anamorphically expanded by passing the substantially collimated beam 131 through at least one of: 1) one or more pairs of crossed cylindrical lenses 304, 306; 2) one or more cylindrical telescopes 402, 404; 3) one or more anamorphic prisms, 502, 504, 506, 508, 510; or 4) one or more diffractive elements 802, 804. The substantially collimated beam 131 can additionally or alternatively be asymmetrically or anamorphically expanded by moving the lens 902 of the asymmetric beam expander group 900 along the optical axis 204 to switch the asymmetric beam expander group 900 between a high irradiance mode and a low irradiance mode.

The collimated beam 131 is transformed into the shaped sampling beam 134 in some implementations by transforming the substantially collimated beam 131 into the first shaped beam 206 having a first aspect ratio using the asymmetric beam expander group 132, 300, 400, 800, 900, 1200 having one or more optical elements 203 disposed along the optical axis 204 and asymmetrically or anamorphically expanding the first shaped beam 206 having the first aspect ratio using the asymmetric beam expander group 132, 300, 400, 800, 900, 1200 to form the second shaped beam 208 having a second different aspect ratio. The collimated beam 131 can be transformed into the shaped sampling beam 134 by transforming the second shaped beam 208 into the shaped sampling beam 134 at or near the focal plane 135 of the optical assembly 129, 201 using the objective group 136 disposed along the optical axis 204. The first shaped beam 206 can be asymmetrically or anamorphically expanded by magnifying the first shaped beam 206 by a first magnification in a first axis and by a second different magnification in a second different axis. The first magnification is at least twice the second magnification, in some implementations.

The first shaped beam 206 can be asymmetrically or anamorphically expanded in some implementations by passing the first shaped beam 206 through one or more pairs 302 of crossed cylindrical lenses 304, 306. The first shaped beam 206 can be asymmetrically or anamorphically expanded in some implementations by passing the first shaped beam 206 through one or more cylindrical telescopes 402, 404. The first shaped beam 206 can be asymmetrically or anamorphically expanded in some implementations by passing the first shaped beam 206 through one or more anamorphic prisms 502, 504, 506, 508, 510. The first shaped beam 206 can be asymmetrically or anamorphically expanded in some implementations by passing the first shaped beam 206 through one or more diffractive elements 802, 804. The first shaped beam 206 can be asymmetrically or anamorphically expanded in some implementations by passing the first shaped beam 206 through the lens 902 and moving the lens 902 along the optical axis 204 to switch the asymmetric beam expander group 900 between a high irradiance mode and a low irradiance mode.

The sample 211 is optically probed with the shaped sampling beam 134 (Block 1806). Image data associated with the sample 211 is obtained in response to the optical probing of the sample 211 with the shaped sampling beam 134 (Block 1808). The shaped sampling beam 134 is swept across the sample 211 (Block 1810). The shaped sampling beam 134 is swept across the sample 211 in some implementations by directing the shaped beam 137, 208 to the reflective element 1204 and rotating the reflective element 1204 with the actuator 1202. The shaped sampling beam 134 is swept across the sample 211 in some implementations by directing the second shaped beam 208 to the reflective element 1204 and rotating the reflective element 1204 with the actuator 1202. The shaped beam 137, 208 can be passed through at least one of the crossed pair of cylindrical lens 304, 306, the cylindrical telescope 402, 404, the anamorphic prism 502, 504, 506, 508, 510, and/or the diffractive element 802, 804 to anamorphically expand the shaped beam 137, 208 along a first axis and the reflective element 1204 can rotate to sweep the shaped sampling beam 134 along a second, different axis. The first axis may be the x-axis and the second axis may be the y-axis.

An apparatus, comprising: a flow cell to receive a sample; a system, comprising: a flow cell receptacle to receive the flow cell; and an imaging system including: a light source assembly to form a substantially collimated beam; an optical assembly including an asymmetric beam expander group that includes one or more asymmetric elements or anamorphic elements disposed along an optical axis, the optical assembly to receive the substantially collimated beam from the light source assembly, and transform the substantially collimated beam into a shaped sampling beam having an elongated cross section in a far field at or near a focal plane of the optical assembly to optically probe the sample in the flow cell; and an imaging device to obtain image data associated with the sample in response to the optical probing of the sample with the shaped sampling beam.

The apparatus of any one or more of the preceding implementations and/or any one or more of the implementations disclosed below, wherein the substantially collimated beam has a first aspect ratio and the shaped sampling beam has a second aspect ratio.

The apparatus of any one or more of the preceding implementations and/or any one or more of the implementations disclosed below, wherein the first aspect ratio of the substantially collimated beam is at most 4:1, and the second aspect ratio of the shaped sampling beam is at least 8:1.

The apparatus of any one or more of the preceding implementations and/or any one or more of the implementations disclosed below, wherein the asymmetric beam expander group is to provide a first magnification in a first axis, and a second different magnification in a second different axis.

The apparatus of any one or more of the preceding implementations and/or any one or more of the implementations disclosed below, wherein the first magnification is at least twice the second magnification.

The apparatus of any one or more of the preceding implementations and/or any one or more of the implementations disclosed below, wherein the optical assembly comprises: the asymmetric beam expander group to asymmetrically or anamorphically expand the substantially collimated beam having a first aspect ratio to form a shaped beam having a second different aspect ratio; and an objective group disposed along the optical axis to receive the shaped beam from the asymmetric beam expander group, and transform the shaped beam into the shaped sampling beam at or near the focal plane of the optical assembly.

The apparatus of any one or more of the preceding implementations and/or any one or more of the implementations disclosed below, wherein the light source assembly includes: a beam source to provide input radiation, and a collimator to substantially collimate the input radiation to form the substantially collimated beam having a first aspect ratio.

The apparatus of any one or more of the preceding implementations and/or any one or more of the implementations disclosed below, wherein the collimator includes a waveguide having the first aspect ratio.

The apparatus of any one or more of the preceding implementations and/or any one or more of the implementations disclosed below, wherein the waveguide comprises at least one of a rectangular optical fiber, or a light pipe having the first aspect ratio.

The apparatus of any one or more of the preceding implementations and/or any one or more of the implementations disclosed below, wherein the collimator includes at least one of a spherical lens or an aspherical lens disposed to collimate an output of the optical fiber.

The apparatus of any one or more of the preceding implementations and/or any one or more of the implementations disclosed below, wherein the optical assembly comprises: a beam shaping group having one or more optical elements disposed along the optical axis to receive the substantially collimated beam from the collimator, and transform the substantially collimated beam into a first shaped beam having a first aspect ratio; the asymmetric beam expander group is to asymmetrically or anamorphically expand the first shaped beam having the first aspect ratio to form a second shaped beam having a second different aspect ratio; and an objective group disposed along the optical axis to receive the second shaped beam from the asymmetric beam expander group, and transform the second shaped beam into the shaped sampling beam at or near the focal plane of the optical assembly.

The apparatus of any one or more of the preceding implementations and/or any one or more of the implementations disclosed below, wherein the imaging device includes a time domain integration (TDI) image sensor having an aspect ratio corresponding to an aspect ratio of the sampling beam.

The apparatus of any one or more of the preceding implementations and/or any one or more of the implementations disclosed below, wherein the asymmetric beam expander group includes one or more pairs of crossed cylindrical lenses disposed along the optical axis.

The apparatus of any one or more of the preceding implementations and/or any one or more of the implementations disclosed below, wherein each pair of the one or more pairs of crossed cylindrical lenses includes two cylindrical lenses with different powers and oriented on different axes.

The apparatus of any one or more of the preceding implementations and/or any one or more of the implementations disclosed below, wherein the asymmetric beam expander group includes a cylindrical telescope disposed along the optical axis.

The apparatus of any one or more of the preceding implementations and/or any one or more of the implementations disclosed below, wherein the cylindrical telescope includes a singlet lens.

The apparatus of any one or more of the preceding implementations and/or any one or more of the implementations disclosed below, wherein the cylindrical telescope includes an afocal doublet lens.

The apparatus of any one or more of the preceding implementations and/or any one or more of the implementations disclosed below, wherein the doublet lens is achromatic.

The apparatus of any one or more of the preceding implementations and/or any one or more of the implementations disclosed below, wherein the cylindrical telescope is at least one of a Keplerian telescope, a Galilean telescope, or a hybrid Keplerian-Galilean telescope.

The apparatus of any one or more of the preceding implementations and/or any one or more of the implementations disclosed below, wherein the asymmetric beam expander group includes a second cylindrical telescope.

The apparatus of any one or more of the preceding implementations and/or any one or more of the implementations disclosed below, wherein the cylindrical telescope and the second cylindrical telescope are at least one of in series, nested, or interleaved.

The apparatus of any one or more of the preceding implementations and/or any one or more of the implementations disclosed below, wherein the cylindrical telescope and the second cylindrical telescope magnify by different amounts in different axes.

The apparatus of any one or more of the preceding implementations and/or any one or more of the implementations disclosed below, wherein the asymmetric beam expander group includes one or more anamorphic prisms disposed along the optical axis such that magnification is provided in substantially one axis.

The apparatus of any one or more of the preceding implementations and/or any one or more of the implementations disclosed below, wherein the one or more anamorphic prisms comprise a first prism comprising a first glass type and a second prism comprising a second glass type.

An apparatus, comprising: a system, comprising: a flow cell receptacle to receive a flow cell that receives a sample; and an imaging system including: a light source assembly to form a substantially collimated beam; an optical assembly including an asymmetric beam expander group that includes one or more asymmetric elements or anamorphic elements disposed along an optical axis, the optical assembly to receive the substantially collimated beam from the light source assembly, and transform the substantially collimated beam into a shaped sampling beam having an elongated cross section in a far field at or near a focal plane of the optical assembly to optically probe the sample in the flow cell; and an imaging device to obtain image data associated with the sample in response to the optical probing of the sample with the sampling beam.

The apparatus of any one or more of the preceding implementations and/or any one or more of the implementations disclosed below, wherein the asymmetric beam expander group includes one or more diffractive elements disposed along the optical axis.

The apparatus of any one or more of the preceding implementations and/or any one or more of the implementations disclosed below, wherein the one or more diffractive elements comprise at least one of a refractive homogenizer, a refractive diffuser, or a cylindrical microlens array.

The apparatus of any one or more of the preceding implementations and/or any one or more of the implementations disclosed below, wherein the asymmetric beam expander group includes a lens disposed along the optical axis, the imaging system to move the lens along the optical axis to switch the asymmetric beam expander group between a high irradiance mode and a low irradiance mode.

The apparatus of any one or more of the preceding implementations and/or any one or more of the implementations disclosed below, wherein the imaging system further includes an actuator and a reflective element, the actuator to position the reflective element to sweep the shaped sampling beam across the flow cell within an exposure time.

The apparatus of any one or more of the preceding implementations and/or any one or more of the implementations disclosed below, wherein the asymmetric beam expander group further includes at least one of a crossed pair of cylindrical lens, a cylindrical telescope, an anamorphic prism, or a diffractive element to provide anamorphic expansion along a first axis, and wherein the actuator is to position the reflective element to sweep the shaped sampling beam along a second, different axis.

The apparatus of any one or more of the preceding implementations and/or any one or more of the implementations disclosed below, wherein the actuator is to position the reflective element within a range to sweep the shaped sampling beam across the flow cell.

The apparatus of any one or more of the preceding implementations and/or any one or more of the implementations disclosed below, wherein the range is between about 39 degrees and about 41 degrees.

A method, comprising: generating a collimated beam using a light source assembly; transforming the collimated beam into a shaped sampling beam having an elongated cross section in a far field at a focal plane of an optical assembly using the optical assembly, wherein the optical assembly has an asymmetric beam expander group that includes one or more asymmetric elements or anamorphic elements disposed along an optical axis; and optically probing a sample with the shaped sampling beam.

The method of any one or more of the preceding implementations and/or any one or more of the implementations disclosed below, wherein generating the collimated beam comprises passing an input beam through a waveguide.

The method of any one or more of the preceding implementations and/or any one or more of the implementations disclosed below, wherein the waveguide comprises at least one of a rectangular optical fiber or a light pipe.

The method of any one or more of the preceding implementations and/or any one or more of the implementations disclosed below, wherein transforming the collimated beam into the shaped sampling beam includes: asymmetrically or anamorphically expanding the substantially collimated beam having a first aspect ratio using the asymmetric beam expander group to form a shaped beam having a second aspect ratio.

The method of any one or more of the preceding implementations and/or any one or more of the implementations disclosed below, wherein transforming the collimated beam into the shaped sampling beam includes: transforming the shaped beam into the shaped sampling beam at or near the focal plane of the optical assembly using an objective group disposed along the optical axis.

The method of any one or more of the preceding implementations and/or any one or more of the implementations disclosed below, wherein asymmetrically or anamorphically expanding the substantially collimated beam includes passing the substantially collimated beam through at least one of: 1) one or more pairs of crossed cylindrical lenses; 2) one or more cylindrical telescopes; 3) one or more anamorphic prisms; or 4) one or more diffractive elements.

The method of any one or more of the preceding implementations and/or any one or more of the implementations disclosed below, wherein asymmetrically or anamorphically expanding the substantially collimated beam includes moving a lens of the asymmetric beam expander group along the optical axis to switch the asymmetric beam expander group between a high irradiance mode and a low irradiance mode.

The method of any one or more of the preceding implementations and/or any one or more of the implementations disclosed below, further comprising sweeping the shaped sampling beam across the sample.

The method of any one or more of the preceding implementations and/or any one or more of the implementations disclosed below, wherein sweeping the shaped sampling beam across the sample comprises directing the shaped beam to a reflective element and rotating the reflective element with an actuator.

The method of any one or more of the preceding implementations and/or any one or more of the implementations disclosed below, wherein transforming the collimated beam into the shaped sampling beam includes: transforming the substantially collimated beam into a first shaped beam having a first aspect ratio using a beam shaping group having one or more optical elements disposed along the optical axis; and asymmetrically or anamorphically expanding the first shaped beam having the first aspect ratio using the asymmetric beam expander group to form a second shaped beam having a second different aspect ratio.

The method of any one or more of the preceding implementations and/or any one or more of the implementations disclosed below, wherein transforming the collimated beam into the shaped sampling beam includes transforming the second shaped beam into the shaped sampling beam at or near the focal plane of the optical assembly using an objective group disposed along the optical axis.

The method of any one or more of the preceding implementations and/or any one or more of the implementations disclosed below, wherein asymmetrically or anamorphically expanding the first shaped beam magnifies the first shaped beam by a first magnification in a first axis, and by a second different magnification in a second different axis.

The method of any one or more of the preceding implementations and/or any one or more of the implementations disclosed below, wherein the first magnification is at least twice the second magnification.

The method of any one or more of the preceding implementations and/or any one or more of the implementations disclosed below, wherein asymmetrically or anamorphically expanding the first shaped beam includes passing the first shaped beam through one or more pairs of crossed cylindrical lenses.

The method of any one or more of the preceding implementations and/or any one or more of the implementations disclosed below, wherein asymmetrically or anamorphically expanding the first shaped beam includes passing the first shaped beam through one or more cylindrical telescopes.

The method of any one or more of the preceding implementations and/or any one or more of the implementations disclosed below, wherein asymmetrically or anamorphically expanding the first shaped beam includes passing the first shaped beam through one or more anamorphic prisms.

The method of any one or more of the preceding implementations and/or any one or more of the implementations disclosed below, wherein asymmetrically or anamorphically expanding the first shaped beam includes passing the first shaped beam through one or more diffractive elements.

The method of any one or more of the preceding implementations and/or any one or more of the implementations disclosed below, wherein asymmetrically or anamorphically expanding the first shaped beam includes: passing the first shaped beam through a lens; and moving the lens along the optical axis to switch the asymmetric beam expander group between a high irradiance mode and a low irradiance mode.

The method of any one or more of the preceding implementations and/or any one or more of the implementations disclosed below, further comprising sweeping the shaped sampling beam across the sample by directing the second shaped beam to a reflective element and rotating the reflective element with an actuator.

The method of any one or more of the preceding implementations and/or any one or more of the implementations disclosed below, further comprising obtaining image data associated with the sample in response to the optical probing of the sample with the shaped sampling beam.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a flow cell to receive a sample;
a system, comprising:
a flow cell receptacle to receive the flow cell; and
an imaging system including:
a light source assembly to form a substantially collimated beam;
an optical assembly including an asymmetric beam expander group that includes one or more asymmetric elements or anamorphic elements disposed along an optical axis, the optical assembly to receive the substantially collimated beam from the light source assembly, and transform the substantially collimated beam into a shaped sampling beam having an elongated cross section in a far field at or near a focal plane of the optical assembly to optically probe the sample in the flow cell; and
an imaging device to obtain image data associated with the sample in response to the optical probing of the sample with the shaped sampling beam.

2. The apparatus of claim 1, wherein the substantially collimated beam has a first aspect ratio and the shaped sampling beam has a second aspect ratio, wherein the first aspect ratio of the substantially collimated beam is at most 4:1, and the second aspect ratio of the shaped sampling beam is at least 8:1.

3. (canceled)

4. The apparatus of claim 1, wherein the asymmetric beam expander group is to provide a first magnification in a first axis, and a second different magnification in a second different axis, wherein the first magnification is at least twice the second magnification.

5. (canceled)

6. The apparatus of claim 1, wherein the optical assembly comprises:
the asymmetric beam expander group to asymmetrically or anamorphically expand the substantially collimated beam having a first aspect ratio to form a shaped beam having a second different aspect ratio; and
an objective group disposed along the optical axis to receive the shaped beam from the asymmetric beam expander group, and transform the shaped beam into the shaped sampling beam at or near the focal plane of the optical assembly.

7. The apparatus of claim 1, wherein the light source assembly includes:
a beam source to provide input radiation, and
a collimator to substantially collimate the input radiation to form the substantially collimated beam having a first aspect ratio.

8. The apparatus of claim 7, wherein the collimator includes a waveguide having the first aspect ratio, wherein the waveguide comprises at least one of a rectangular optical fiber, or a light pipe having the first aspect ratio, and wherein the collimator includes at least one of a spherical lens or an aspherical lens disposed to collimate an output of the optical fiber.

9-10. (canceled)

11. The apparatus of claim 1, wherein the optical assembly comprises:
a beam shaping group having one or more optical elements disposed along the optical axis to receive the substantially collimated beam from the collimator, and transform the substantially collimated beam into a first shaped beam having a first aspect ratio;
the asymmetric beam expander group is to asymmetrically or anamorphically expand the first shaped beam having the first aspect ratio to form a second shaped beam having a second different aspect ratio; and
an objective group disposed along the optical axis to receive the second shaped beam from the asymmetric beam expander group, and transform the second shaped beam into the shaped sampling beam at or near the focal plane of the optical assembly.

12. The apparatus of claim 1, wherein the imaging device includes a time domain integration (TDI) image sensor having an aspect ratio corresponding to an aspect ratio of the sampling beam.

13. The apparatus of claim 1, wherein the asymmetric beam expander group includes one or more pairs of crossed cylindrical lenses disposed along the optical axis, wherein each pair of the one or more pairs of crossed cylindrical lenses includes two cylindrical lenses with different powers and oriented on different axes.

14. (canceled)

15. The apparatus of claim 1, wherein the asymmetric beam expander group includes a cylindrical telescope disposed along the optical axis.

16. The apparatus of claim 15, wherein the cylindrical telescope includes a singlet lens or an afocal doublet lens that is achromatic.

17-19. (canceled)

20. The apparatus of claim 1, wherein the asymmetric beam expander group includes a second cylindrical telescope, wherein the cylindrical telescope and the second cylindrical telescope magnify by different amounts in different axes.

21. The apparatus of claim 20, wherein the cylindrical telescope and the second cylindrical telescope are at least one of in series, nested, or interleaved.

22. (canceled)

23. The apparatus of claim 1, wherein the asymmetric beam expander group includes one or more anamorphic prisms disposed along the optical axis such that magnification is provided in substantially one axis.

24. The apparatus of claim 23, wherein the anamorphic prisms comprise a first prism comprising a first glass type and a second prism comprising a second glass type.

25. An apparatus, comprising:
a system, comprising:
a flow cell receptacle to receive a flow cell that receives a sample; and
an imaging system including:
a light source assembly to form a substantially collimated beam;
an optical assembly including an asymmetric beam expander group that includes one or more asymmetric elements or anamorphic elements disposed along an optical axis, the optical assembly to receive the substantially collimated beam from the light source assembly, and transform the substantially collimated beam into a shaped sampling beam having an elongated cross section in a far field at or near a focal plane of the optical assembly to optically probe the sample in the flow cell; and
an imaging device to obtain image data associated with the sample in response to the optical probing of the sample with the sampling beam.

26. The apparatus of 25, wherein the asymmetric beam expander group includes one or more diffractive elements disposed along the optical axis, wherein the one or more diffractive elements comprise at least one of a refractive homogenizer, a refractive diffuser, or a cylindrical microlens array.

27. (canceled)

28. The apparatus of claim 25, wherein the asymmetric beam expander group includes a lens disposed along the optical axis, the imaging system to move the lens along the optical axis to switch the asymmetric beam expander group between a high irradiance mode and a low irradiance mode.

29. The apparatus of claim 25, wherein the imaging system further includes an actuator and a reflective element, the actuator to position the reflective element to sweep the shaped sampling beam across the flow cell within an exposure time.

30. The apparatus of claim 29, wherein the asymmetric beam expander group further includes at least one of a crossed pair of cylindrical lens, a cylindrical telescope, an anamorphic prism, or a diffractive element to provide anamorphically expansion along a first axis, and wherein the actuator is to position the reflective element to sweep the shaped sampling beam along a second, different axis.

31. The apparatus of claim 29, wherein the actuator is to position the reflective element within a range to sweep the shaped sampling beam across the flow cell.

32. (canceled)

33. A method, comprising:
generating a collimated beam using a light source assembly;
transforming the collimated beam into a shaped sampling beam having an elongated cross section in a far field at a focal plane of an optical assembly using the optical assembly, wherein the optical assembly has an asymmetric beam expander group that includes one or more asymmetric elements or anamorphic elements disposed along an optical axis; and
optically probing a sample with the shaped sampling beam.

34. The method of claim 33, wherein generating the collimated beam comprises passing an input beam through a waveguide, wherein the waveguide comprises at least one of a rectangular optical fiber or a light pipe.

35. (canceled)

36. The method of claim 33, wherein transforming the collimated beam into the shaped sampling beam includes asymmetrically or anamorphically expanding the substantially collimated beam having a first aspect ratio using the asymmetric beam expander group to form a shaped beam having a second aspect ratio.

37. The method of any one of claim 36, wherein transforming the collimated beam into the shaped sampling beam includes transforming the shaped beam into the shaped sampling beam at or near the focal plane of the optical assembly using an objective group disposed along the optical axis.

38. The method of claim 36, wherein asymmetrically or anamorphically expanding the substantially collimated beam includes passing the substantially collimated beam through at least one of: 1) one or more pairs of crossed cylindrical lenses; 2) one or more cylindrical telescopes; 3) one or more anamorphic prisms; or 4) one or more diffractive elements.

39. The method of claim 36, wherein asymmetrically or anamorphically expanding the substantially collimated beam includes moving a lens of the asymmetric beam expander group along the optical axis to switch the asymmetric beam expander group between a high irradiance mode and a low irradiance mode.

40. The method of claim 36, further comprising sweeping the shaped sampling beam across the sample.

41-52. (canceled)
